(19) United States
(12) Patent Application Publication
(10) Pub. No.: US 2026/0108103 A1
(43) Pub. Date: Apr. 23, 2026

(54) COOKING APPLIANCE

(71) Applicant: StoreBound LLC, New York, NY (US)

(72) Inventors: Evan Marc Dash, New York, NY (US); Qiyuan Dou, Shenzhen (CN); Cheng Zhao, Shenzhen (CN); Yiyang Zhang, Shenzhen (CN)

(73) Assignee: StoreBound LLC, New York, NY (US)

(21) Appl. No.: 19/353,148

(22) Filed: Oct. 8, 2025

Related U.S. Application Data
(60) Provisional application No. 63/710,984, filed on Oct. 23, 2024.

(51) Int. Cl. A47J 37/06; F24C 15/32

(52) U.S. Cl. CPC A47J 37/0641; A47J 37/0676; F24C 15/325

(57) ABSTRACT

A cooking appliance includes a base unit and a heating unit. The heating unit may be attached to the base unit in a first cooking position or configuration for heating food located within a cooking receptacle of the base unit. A locking mechanism may lock the heating unit to the base unit in the first cooking position. The heating unit may be detached from the base and placed atop of a support surface in a second cooking position that is an inverted orientation relative to the first cooking position. In the second cooking position, food may be placed onto the exposed upper surface of the heating unit for cooking. In the second cooking position, a cooking plate may be placed atop of the upper surface of the heating unit to support food thereon for cooking.

### CROSS-REFERENCE TO RELATED APPLICATIONS

The present application claims the benefit of priority to U.S. Provisional Patent Application Ser. No. 63/710,984, filed Oct. 23, 2024, the entirety of which is incorporated herein by reference.

### BACKGROUND OF THE INVENTION

Professional and home chefs alike continually struggle with reducing countertop clutter and maintaining an aesthetically pleasing kitchen while striving to preserve the functionality of the kitchen. Electric appliances have been in use for some time, which allow a user to store the appliance in a cabinet when not in use, thereby freeing up countertop space. A need exists for an electric cooking appliance that has multiple cooking functions to further reduce countertop clutter and provide users with additional cooking options.

### BRIEF SUMMARY OF THE INVENTION

A cooking appliance includes a base unit and a heating unit. The heating unit may be attached to the base unit in a first cooking position or configuration for heating food located within a cooking receptacle of the base unit. The heating unit may be detached from the base and placed atop of a support surface in a second cooking position that is an inverted orientation relative to the first cooking position. In the second cooking position, food may be placed onto the exposed upper surface of the heating unit for cooking.

In one aspect, the invention may be a cooking appliance comprising: a base unit comprising a cooking receptacle having an open top end; a heating unit comprising: a first end and a second end opposite the first end, the first end comprising one or more support elements; and a heat generating assembly configured to generate heat and emit the heat from the second end of the heating unit for cooking; wherein the heating unit is detachably coupled to the base unit, the heating unit being alterable between: (1) a first cooking position wherein the heating unit is positioned atop of the base unit to close the open top end of the cooking receptacle with the second end of the heating unit facing the cooking receptacle of the base unit to cook food located within the cooking receptacle of the base unit; and (2) a second cooking position wherein the heating unit is separated and detached from the base unit and inverted relative to the first cooking position so that the one or more support elements are in contact with a support surface and the second end of the heating unit is configured to receive food thereon for cooking.

In another aspect, the invention may be a cooking appliance comprising: a base unit comprising an outer surface and a cooking receptacle having an open top end, a first locking protuberance protruding from a first side of the outer surface of the base unit and a second locking protuberance protruding from a second side of the outer surface of the base unit; a heating unit comprising an outer surface, a heat generating assembly configured to generate heat for cooking, a first latch bar located on a first side of the outer surface of the heating unit, and a second latch bar located on a second side of the outer surface of the heating unit, the first and second latch bars being pivotable relative to the outer surface of the heating unit; the heating unit being detachably coupled to the base unit in a first cooking position wherein the heating unit closes the open top end of the receptacle; and wherein when the heating unit is in the first cooking position, the first and second latch bars are alterable between: (1) an unlocked state wherein the first latch bar does not engage the first locking protuberance and the second latch bar does not engage the second locking protuberance and the heating unit is configured to be freely separated from the base unit; and (2) a locked state wherein the first latch bar engages the first locking protuberance and the second latch bar engages the second locking protuberance to prevent the heating unit from being detached from the base unit.

In yet another aspect, the invention may be a cooking appliance a base unit comprising a cooking receptacle having an open top end; a heating unit comprising: a first end and a second end opposite the first end, the first end comprising one or more support elements; and a heat generating assembly configured to generate heat and emit the heat from the second end of the heating unit for cooking, the heat generating assembly comprising a heating element that is exposed at the second end of the heating unit; wherein the heating unit is alterable between: (1) a first cooking position wherein the heating unit is attached to the base unit and closes the open top end of the cooking receptacle with the second end of the heating unit facing the cooking receptacle to cook food located in the cooking receptacle; and (2) a second cooking position wherein the heating unit is separated from the base unit and positioned with the second end of the heating unit facing upwardly; and a cooking plate configured to be positioned atop of the second end of the heating unit when the heating unit is in the second cooking position, the cooking plate configured to support food thereon to be heated by the heat generated by the heating element of the heat generating assembly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front perspective view of a cooking appliance in accordance with an embodiment of the present invention;

FIG. 2 is an exploded view of the cooking appliance showing a base unit, a heating unit, and a cooking basket thereof;

FIG. 3 is a cross-sectional view taken along line III-III of FIG. 1;

FIG. 4 is a top perspective view of the base unit of the cooking appliance of FIG. 1;

FIG. 5 is a bottom perspective view of the base unit of FIG. 4;

FIG. 6 is a top perspective view of the heating unit of the cooking appliance of FIG. 1;

FIG. 7 is a bottom perspective view of the heating unit of FIG. 6;

FIG. 8A is a top perspective exploded view of the heating unit of FIG. 6;

FIG. 8B is a bottom perspective exploded view of the heating unit of FIG. 6;

FIG. 9 is a perspective view of a support component of the heating unit of the cooking appliance of FIG. 1;

FIG. 10 is a side view of the heating unit detached from the base unit and in a second cooking position;

FIG. 11A is a perspective view of the heating unit with heating elements thereof exposed;

FIG. 11B is a perspective view of the heating unit with a grill plate attached thereto;

FIG. 11C is a perspective view of the heating unit with a griddle plate attached thereto;

FIG. 12A is a front view of the cooking appliance with the heating unit attached to the base unit in a first cooking position;

FIG. 12B is a front view of the heating unit resting atop of a support surface in a second cooking position;

FIG. 13A is a perspective view illustrating the heating unit being prepared for attachment to the base unit in the first cooking position;

FIG. 13B is a perspective view illustrating the heating unit positioned atop of the base unit with a locking mechanism thereof in an unlocked state; and

FIG. 13C is a perspective view illustrating the heating unit positioned atop of the base unit with the locking mechanism thereof in the locked state.

### DETAILED DESCRIPTION OF THE INVENTION

The following description of the preferred embodiment(s) is merely exemplary in nature and is in no way intended to limit the invention, its application, or uses. The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

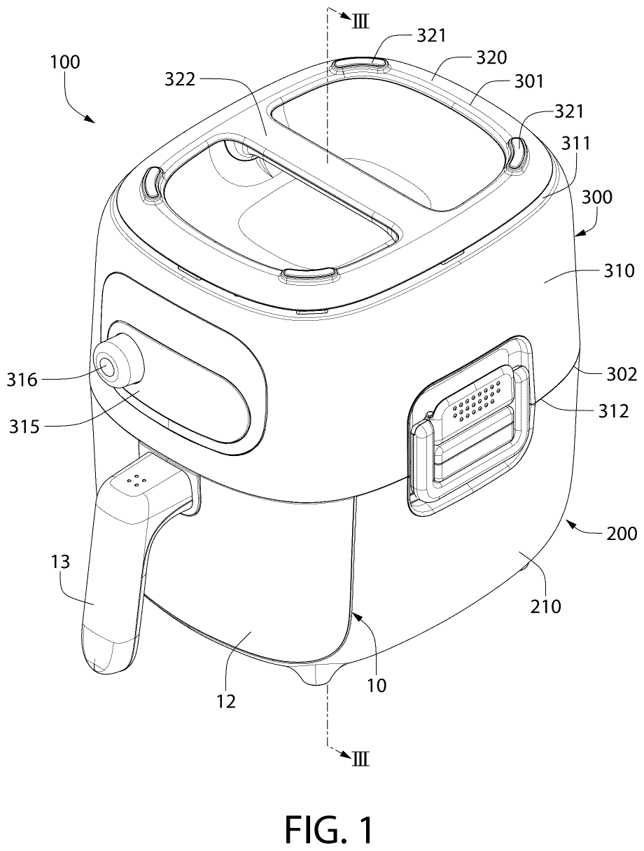

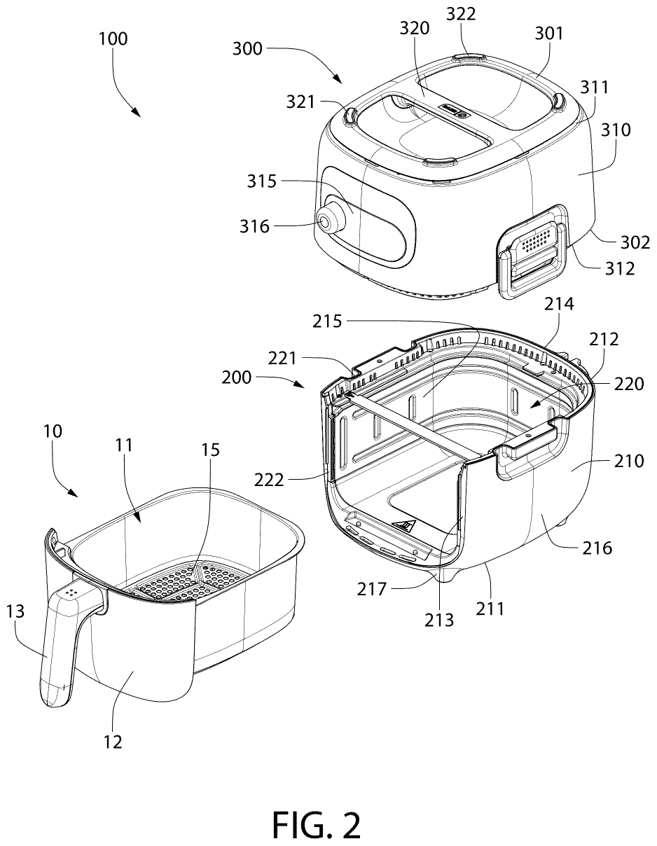

Referring to FIGS. 1-3, a cooking appliance 100 is illustrated in accordance with an embodiment of the present invention. The cooking appliance 100 may be configured to cook food in a plurality of different ways. Specifically, the cooking appliance 100 may function as an air fryer to cook food by circulating hot air within a cooking chamber. Alternatively, the cooking appliance 100 or a part thereof may function as an electric grill or electric stove for heating or cooking food. Although not shown in the figures, it should be readily appreciated that the cooking appliance 100 may include an electric plug for plugging into a wall outlet to supply power to the various electronic components of the cooking appliance 100 which will be described later. The cooking appliance 100 may have multiple cooking functionalities built into a single apparatus.

The cooking appliance 100 may comprise a base unit 200, a heating unit 300, and a cooking basket 10. Each of these components will be briefly described with reference to FIGS. 1-3, with a more detailed description to follow.

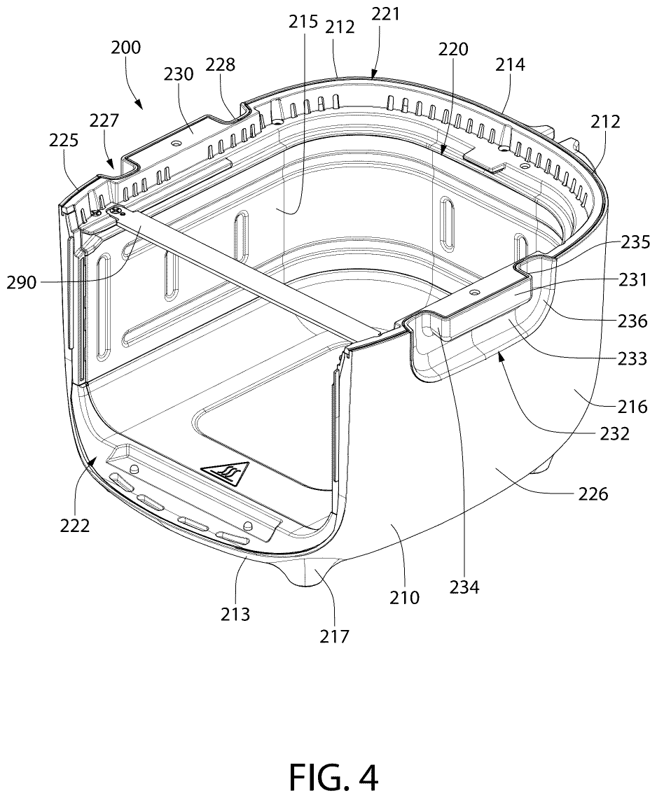

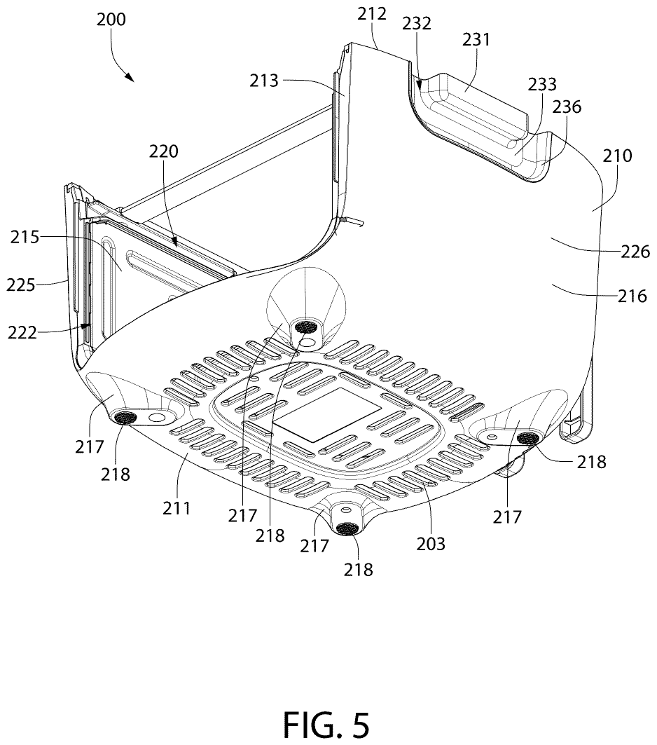

The base unit 200 comprises a base housing 210 having a bottom end 211, a top end 212, a front side 213, a rear side 214, an inner surface 215, and an outer surface 216. The bottom end 211 of the base unit 200 may comprise one or more legs 217 for supporting the base unit 200 on a support surface such as a countertop, a tabletop, or the like. The base housing 210 of the base unit 200 comprises a cooking receptacle 220 that is bounded on three sides by the inner surface 215. The cooking receptacle 220 may comprise an open top end 221 located at the top end 212 of the base housing 210. The cooking receptacle 220 may also comprise a front opening 222 formed into the front side 213 of the base housing 210. Each of the top and front openings 221, 222 may form a passageway into the cooking receptacle 220. Specifically, the top opening 221 may form a passageway into the cooking receptacle 220 from the top end 212 of the base housing 210 and the front opening 222 may form a passageway into the base housing 210 from the front side 213 of the base housing 210. In the exemplified embodiment, the base unit 200 does not comprise any electronic devices, such as motors, heaters, fans, or the like. Further details about the base unit 200 will be provided later on in this document with reference to FIGS. 4 and 5.

The cooking basket 10 is configured to be slidably inserted into the cooking receptacle 220 of the base housing 210 of the base unit 200 via the front opening 222 in the front side 213 of the base housing 210. The cooking basket 10 comprises a food receptacle 11 that is configured to receive and hold food for cooking. The cooking basket 10 comprises a front side 12. The cooking basket 10 comprises a handle 13 located at the front side 12 to assist the user in inserting and removing the cooking basket 10 from the cooking receptacle 220. The handle 13 has an L-shaped configured in the exemplified embodiment, but the handle 13 may take on other structural forms in other embodiments. For example, the handle 13 could be a U-shaped handle, or really any structure that enables a user to grip to facilitate the sliding of the cooking basket 10 into and out of the cooking receptacle 220 of the base unit 200. In an embodiment, the handle could comprise recesses or depressions located on opposing sides of the cooking basket, or tabs that are capable of being gripped by a user, or any other structure that achieves the desired and stated purpose of insertion and removal of the cooking basket 10 from the cooking receptacle 220. A removable support plate 15 may be located within the food receptacle 11 of the cooking basket 10. The removable support plate 15 may be configured to be removed from the cooking basket 10 for cleaning. The removable support plate 15 may form a floor of the food receptacle 11 when positioned in the cooking basket 10.

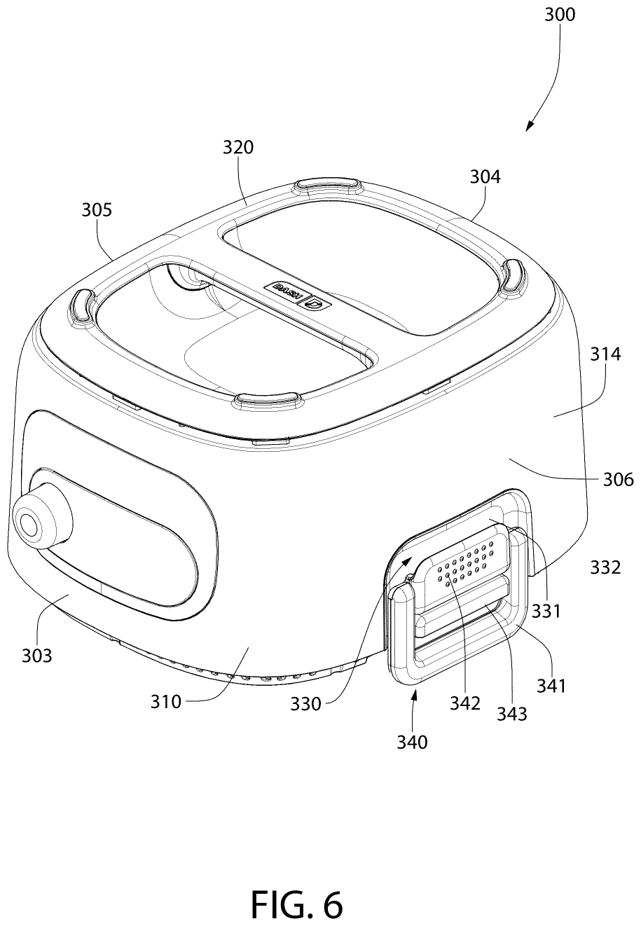

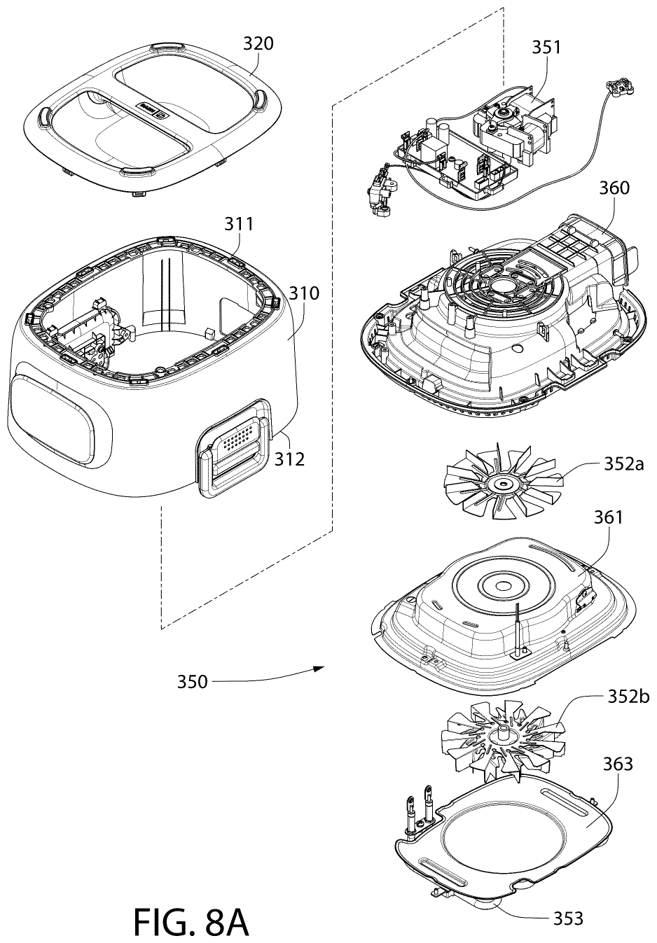

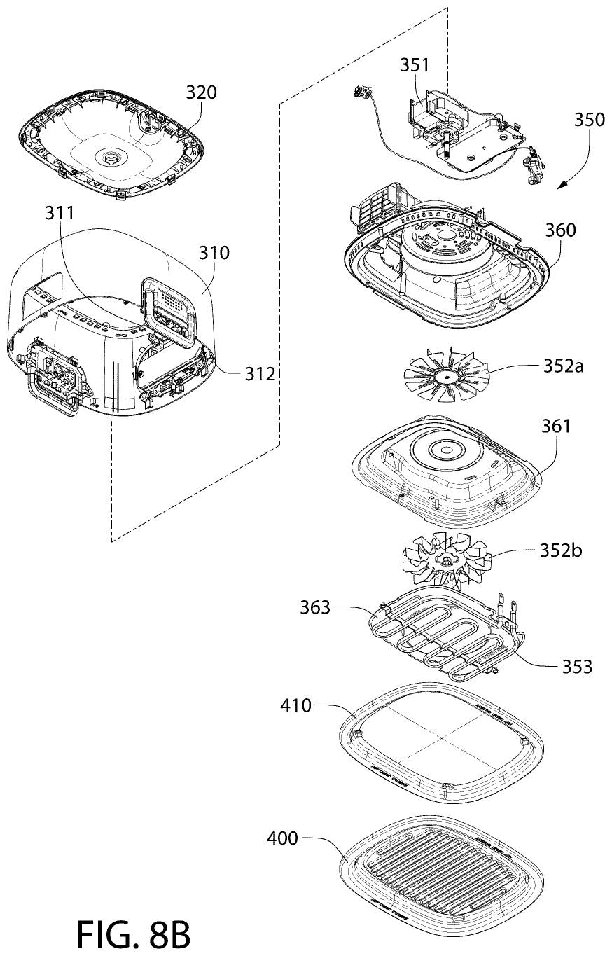

The heating unit 300 comprises a first end 301 and a second end 302 opposite the first end 301. The first end 301 of the heating unit 300 may comprise one or more support elements 321 and a handle 322, as described in more detail below. The heating unit 300 may comprise a main housing body 310 comprising a first end 311 and a second end 312, with the second end 312 of the main housing body 310 forming the second end 302 of the heating unit 300. The heating unit 300 may further comprise a support component 320 that is coupled to the first end 311 of the main housing body 310. The support component 320 may comprise the one or more support elements 321 and the handle 322, as described in more detail below with reference to FIGS. 6, 8A, and 8B.

The main housing body 310 of the heating unit 300 may define a cavity 313 for housing various electronic components of the cooking appliance 100. Specifically, the heating unit 300 may comprise a heat generating assembly 350 that is configured to generate heat and to emit the heat from the second end 302 of the heating unit 300 for cooking. The heat generating assembly 350 may comprise a motor 351, at least one fan 352, and a heating element 353. The motor 351 may be operably coupled to the fan 352 to cause the fan 352 to rotate and generate an air stream. Specifically, when the aforementioned electrical plug is plugged into an outlet and the cooking appliance 100 is powered on, the motor 351 may be activated to rotate, which thereby rotates the at least one fan 352 resulting in the at least one fan 352 generating an air stream that is directed towards the heating element 353 and towards the second end 302 of the cooking appliance 300.

The heating element 353 may comprise one or more resistive coils that generate heat upon receiving electricity. When the electric plug is plugged into an outlet and the cooking appliance 100 is powered on, the heating element 353 may be activated to generate heat. The at least one fan 352 may be positioned upstream of the heating element 353 so that the air stream generated by the at least one fan 352 passes by the heating element 353. As the air stream generated by the at least one fan 352 passes by the heating element 353, the air stream is heated so that hot air is then circulated within the cooking receptacle 220 of the base unit 200, or more specifically within the food receptacle 11 of the cooking basket 10 to cook food located therein.

The main housing body 310 may comprise an outer surface 314. The main housing body 310 may further comprise a display 315 located on the outer surface 314. The display 315 may display various information to a user related to the function of the cooking appliance. For example, the display 315 may display a cooking temperature, a cooking time, a timer, a cooking type (such as air fry, roast, broil, bake, reheat), or the like. The display 315 may be a touch screen in some embodiments, thereby allowing a user to adjust any of the aforementioned cooking parameters by directly engaging with the display 315. For example, the user may select the type of cooking by selecting one of the air fry, roast, broil, bake, or reheat options, the user may adjust the cooking time and/or temperature by engaging with up and down arrows on the display, and the user may power the cooking appliance on and off using an on/off or start/stop button on the display 315. In some embodiments, the main housing body 310 may comprise an adjustment knob 316 located along or adjacent to the display 315. In such embodiments, the user may rotate the adjustment knob 316 to adjust the cooking time, cooking temperature, or other cooking parameters. In other embodiments, the cooking parameters may be adjusted with a remote or other handheld device. In some embodiments, the cooking parameters may be adjustable with a software application downloaded onto the user's personal electronic device such as the user's cell phone or the like.

FIGS. 1-3 illustrate the cooking appliance 100 with the heating unit 300 in a first cooking position whereby the cooking appliance 100 is configured to cook food held in the cooking basket 10 which is located within the cooking receptacle 220 of the base unit 200. In the first cooking position, the heating unit 300 is positioned atop of the top end 212 of the base housing 210 of the base unit 200 to close the open top end 221 of the cooking receptacle 220. In the first cooking position, the second end 302 of the heating unit 300 faces the cooking receptacle 220 of the base unit 200. As such, the heat (e.g., hot air formed by the air stream mixing with heat generated by the heating element 353) generated by the heat generating assembly 350 of the heating unit 300 is emitted from the second end 302 of the heating unit 300 and into the cooking receptacle 220 of the base unit 200 (and into the food receptacle 11 of the cooking basket 10). In the first cooking position, the first end 301 of the heating unit 300 faces upward so that the handle 322 is accessible to a user to lift and move the assembled cooking appliance.

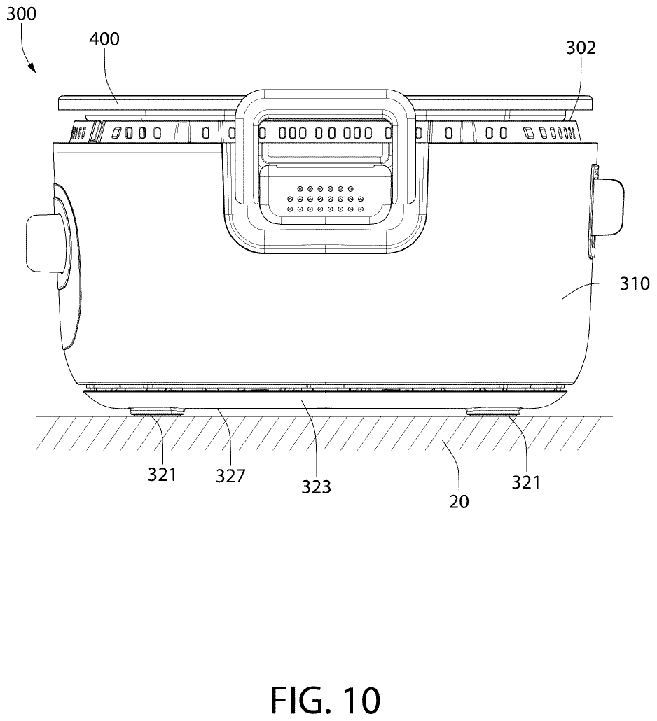

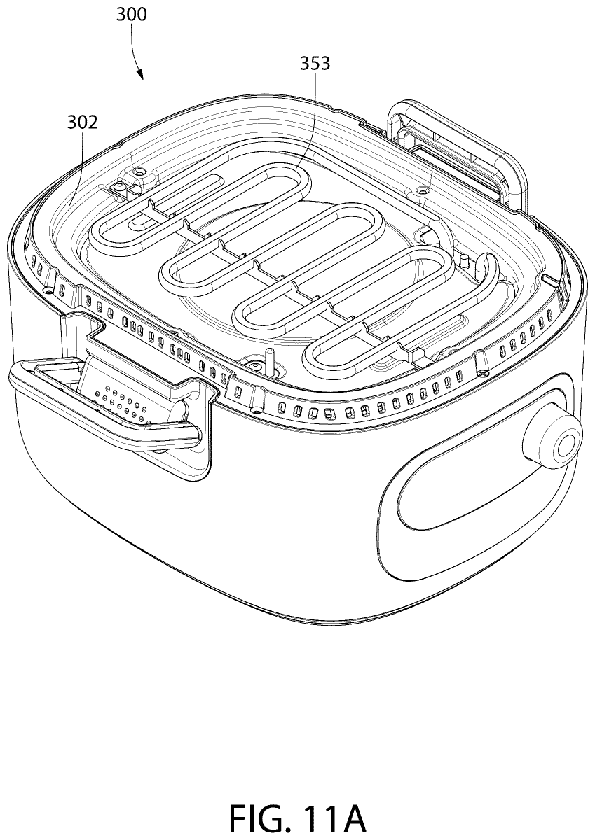

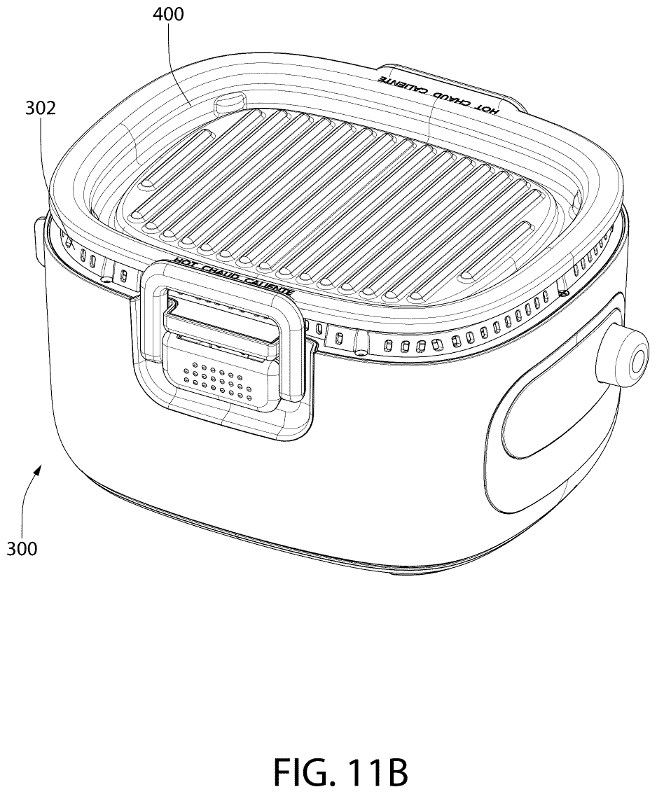

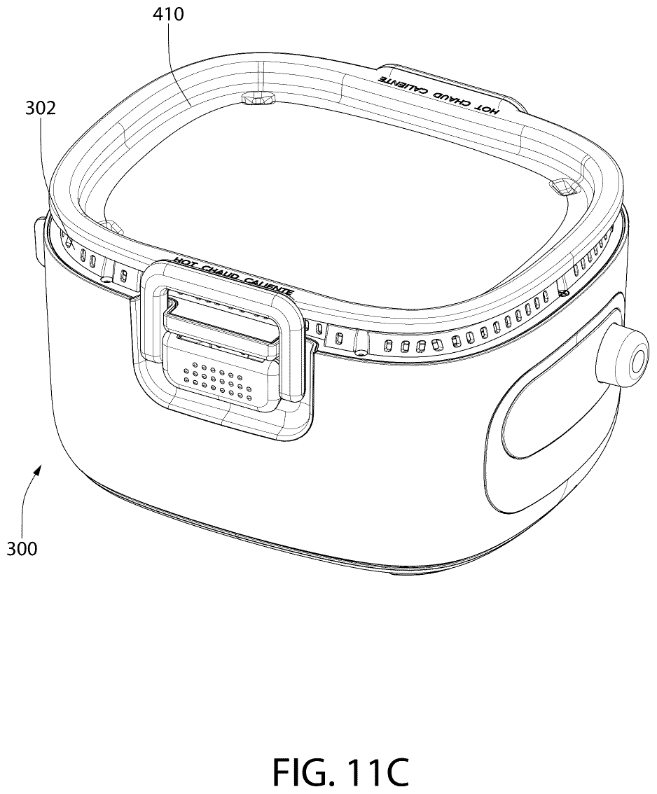

When the heating unit 300 is in the first cooking position, generally the bottom end 211 of the base unit 200 is in contact with a support surface such as a countertop, a tabletop, or any other desired surface. The one or more legs 217 of the base unit 200 may directly contact the tabletop, countertop, or the like, and the heating unit 300 may be elevated above the support surface due to being attached to the top end 212 of the base housing 200. The heating unit 300 may be altered into a second cooking position whereby the first end 301 of the heating unit 300 is in direct contact with the support surface to cook foods located on the second end 302 of the heating unit 300, as described below with reference to FIGS. 10-11C, for example.

Referring to FIGS. 4 and 5, the base unit 200 is illustrated and will be described. As noted, the base unit 200 comprises the base housing 210 having the bottom end 211 and the top end 212. The base housing 210 comprises one or more legs 217 on the bottom end 211. The one or more legs 217 may protrude from the bottom end 211 of the base housing 210 to elevate the bottom end 211 of the base housing 210 from the support surface on which the base unit 200 is resting. The bottom end 211 of the base housing 210 may comprise openings 203 to help with air flow and circulation, and as such elevating the bottom end 211 of the base housing 210 may ensure that the openings 203 are not blocked during use. In the exemplified embodiment, the one or more legs 217 comprises four of the legs arranged in a spaced apart manner along the bottom end 211 of the base housing 210. Each of the legs 217 may comprise a pad 218 formed from rubber or foam or the like to generate friction between the legs 217 and the support surface (i.e., countertop, tabletop, etc.) while also preventing the legs 217 from scratching the support surface.

As noted above, the base unit 200 comprises a front opening 222 through which the cooking basket 10 may be inserted into and removed from the cooking receptacle 220. The base unit 200 also comprises the top opening 221 through which the heated air generated by the heating unit 300 enters the cooking receptacle 220 during cooking. The base housing 210 of the base unit 200 comprises the inner surface 215 that bounds and defines the cooking receptacle 220 and the outer surface 216.

The base housing 210 may comprise a first lateral side 225 and a second lateral side 226 opposite the first lateral side 225. The first and second lateral sides 225, 226 may extend between the front and rear sides 213, 214. The base housing 210 may comprise at least one locking protuberance 230. More specifically, the base housing 210 may comprise a first locking protuberance 230 located on the first lateral side 225 and a second locking protuberance 231 located on the second lateral side 225. The first and second locking protuberances 230, 231 may be configured to engage with locking features of the heating unit 300 to facilitate an attachment between the heating unit 300 and the base unit 200 during cooking operations, as described in more detail below.

The first lateral side 225 of the base housing 210 may comprise a first recess or depression 227 formed into the outer surface 216 of the base housing 210. The first recess 227 may extend from the top end 212 of the base housing 210 downwardly towards the bottom end 213 of the base housing 210. The first recess 227 may extend approximately between one-tenth and one-third of the height of the base housing 210 as measured between the top and bottom ends 212, 213. The first recess 227 may have a floor 228 that is recessed relative to the outer surface 216 of the base housing 210. The first locking protuberance 230 may protrude from the floor 228 of the first recess 227 at or adjacent to the top end 212 of the base housing 210. The first locking protuberance 230 may have an upper surface that is flush with the top end 212 of the base housing 210. The first locking protuberance 230 may be elongated in a direction between the front and rear sides 213, 214 of the base housing 210. The first locking protuberance 230 may have a lower surface that is spaced apart from a bottom end of the first recess 227. Thus, a latch or the like may be configured to nest within the space between the lower surface of the first locking protuberance 230 and the bottom end of the first recess 227. Alternatively, the first locking protuberance 230 may function as a handle, with the space between the lower surface of the first locking protuberance 230 and the bottom end of the first recess 227 permitting a user to insert their fingers or hand for purposes of lifting and moving the base unit 200.

The second lateral side 226 of the base housing 210 may comprise a second recess or depression 232 formed into the outer surface 216 of the base housing 210. The second recess 232 may extend from the top end 212 of the base housing 210 downwardly towards the bottom end 213 of the base housing 210. The second recess 232 may extend approximately between one-tenth and one-third of the height of the base housing 210 as measured between the top and bottom ends 212, 213. The second recess 232 may have a floor 233 that is recessed relative to the outer surface 216 of the base housing 210. The second locking protuberance 231 may protrude from the floor 233 of the second recess 232 at or adjacent to the top end 212 of the base housing 210. The second locking protuberance 231 may have an upper surface that is flush with the top end 212 of the base housing 210. The second locking protuberance 231 may be elongated in a direction between the front and rear sides 213, 214 of the base housing 210. The second locking protuberance 231 may have a lower surface that is spaced apart from a bottom end of the second recess 232. Thus, a latch or the like may be configured to nest within the space between the lower surface of the second locking protuberance 231 and the bottom end of the first recess 227. Alternatively, the second locking protuberance 231 may function as a handle, with the space between the lower surface of the second locking protuberance 231 and the bottom end of the second recess 232 permitting a user to insert their fingers or hand for purposes of lifting and moving the base unit 200.

While the figures show more details of the second recess 232 and the second locking protuberance 231, it should be appreciated that the first recess 227 and the first locking protuberance 230 are identical to the second recess 232 and the second locking protuberance 231, except for the specific lateral side on which it is located. Thus, while the following comment is made with reference to the second locking protuberance 231 and the second recess 232, it is similarly applicable to the first locking protuberance 230 and the first recess 227.

The second locking protuberance 231 extends from a first end 234 to a second end 235. The second locking protuberance 231 is elongated in a direction between the first and second ends 234, 235. The second recess 232 comprises the floor 233 and a sidewall 236 that extends from the floor 233 of the second recess 232 to the outer surface 216 of the base housing 210 of the base unit 200. Each of the first and second ends 234, 235 of the second locking protuberance 231 is spaced apart from the sidewall 236 of the second recess 232. Furthermore, the lower surface of the second locking protuberance 231 is also spaced apart from the sidewall 236 of the second recess 232. Thus, the second recess 232 forms a U-shaped recess that bounds the first and second ends 234, 235 of the second locking protuberance 231 and the lower surface of the second locking protuberance 231.

The base unit 200 may comprise an elongated bar 290 that is attached to the base housing 210 at or adjacent to the top end 212 of the base housing 210. The elongated bar 290 may extend across the a top end of the cooking receptacle 220 at a position that is adjacent to the front side of the base housing 210. The elongated bar 290 may be secured to the base housing 210 with fasteners such as screws, although other attachments can be used including snap-fit, indent/detent, etc. The elongated bar 290 may function to ensure that the cooking basket 10 is properly positioned when inserted into the cooking receptacle 220. Specifically, the elongated bar 290 may be adjacent to a top end of the cooking basket 10 when the cooking basket 10 is positioned within the cooking receptacle 220 of the base unit 200 to prevent the cooking basket 10 from being lifted out of the cooking receptacle 220 via the open top end 221. Instead, due to the elongated bar 290, the cooking basket 10 may be capable of being inserted into and removed from the cooking receptacle 220 via the front opening 222 only. In an embodiment, the elongated bar 290 may be located between the locking protuberances 230, 231 and the front side 213 of the base housing 210.

Additionally, the elongated bar 290 may prevent the heating unit 300 from being positioned atop of the top end 212 of the base housing 210 of the base unit 200 when the heating unit 300 is in an inverted position (referred to herein as a second cooking position). Specifically, due to the elongated bar 290 extending across the cooking receptacle 220, the heating unit 300 may be incapable of resting on the top end 212 of the base housing 210 in a stable manner with the first end 301 of the heating unit 300 facing the cooking receptacle 220. Thus, in some embodiments, the only place for the heating unit 300 to be positioned when in the inverted position for cooking food in the second cooking position is on a support surface such as a tabletop, a countertop, or the like. That is, when the heating unit 300 is in the inverted or second cooking position, the heating unit 300 is not attached to or located on the base unit 200, but is entirely separate from the base unit 200 and operates as a stand-alone unit.

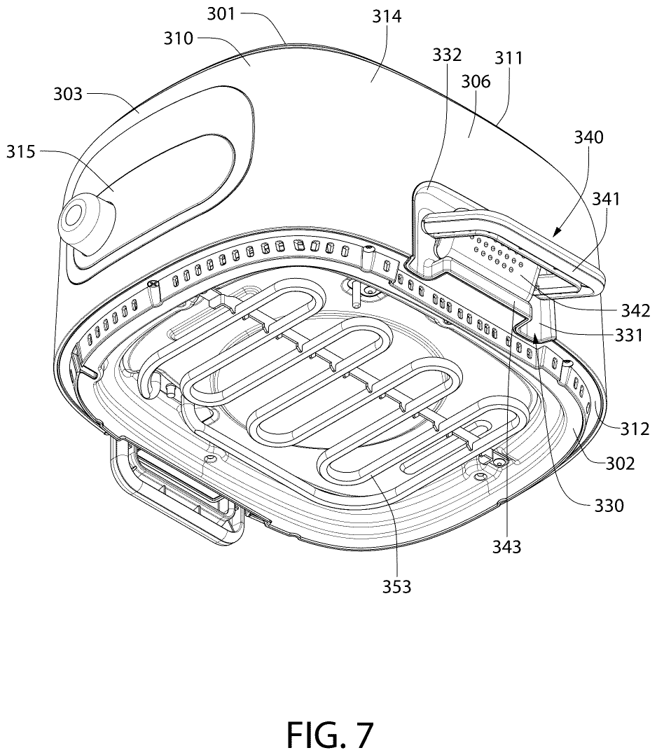

Referring to FIGS. 6 and 7, the heating unit 300 is illustrated. As noted above, the heating unit 300 comprises the first end 301 and the second end 302. In the exemplified embodiment, the heating element 353 is located at the second end 302 of the heating unit 300. The heating element 353 may be exposed at the second end 302 of the heating unit 300. Thus, it can be appreciated that when the heating unit 300 is coupled to the base unit 200 as shown in FIG. 1, the heat emitted by the heating element 353 will flow into the cooking receptacle 220 of the base unit 200 through the open top end 221 of the cooking receptacle 220. In the exemplified embodiment, the heating element 353 comprises a resistive coil having a serpentine or sinusoidal shape or arrangement. In other embodiments, the heating element 353 may take on other arrangements, and may include more than one heating element.

As described above, the heating unit 300 comprises the main housing body 310 and the support component 320. The main housing body 310 comprises the outer surface 314 as described previously. The main housing body 310 may comprise a front side 303 on which the display 315 is located, a back side 304 opposite the front side 303, a first lateral side 305, and a second lateral side 306 opposite the first lateral side 305. The first and second lateral sides 305, 306 may extend between the front and rear sides 303, 304. The heating unit 300 may comprise at least one locking mechanism that is configured to cooperate with one of the locking protuberances 230, 231 of the base unit 200 to lock the heating unit 300 to the base unit 200 when in the first cooking position. More specifically, in the exemplified embodiment the heating unit 300 comprises two of the locking mechanisms, one on each of the first and second lateral sides 305, 306 of the main housing body 310. FIGS. 6 and 7 only illustrate the second lateral side 306, and therefore the locking mechanism on the second lateral side 306 will be described, it being understood that an identical structure and components exist on the first lateral side 305.

The second lateral side 306 of the main housing body 310 of the heating unit 300 may comprise a third recess or depression 330 that extends from the second end 312 of the main housing body 310 towards the first end 311 of the main housing body 310. The third recess 330 may comprise a floor 331 that is recessed relative to the outer surface 314 of the main housing body 310 and a sidewall 332 that extends from the floor 331 to the outer surface 314 of the main housing body 310. As noted, a first locking mechanism (not shown) may be located on the first lateral side 305 of the main housing body 310 and a second locking mechanism 340 may be located on the second lateral side 306 of the main housing body 310. While the first locking mechanism is not shown in the drawings, it should be understood that it may be identical to the second locking mechanism 340 and thus the discussion of the second locking mechanism 340 may be applicable to the first locking mechanism.

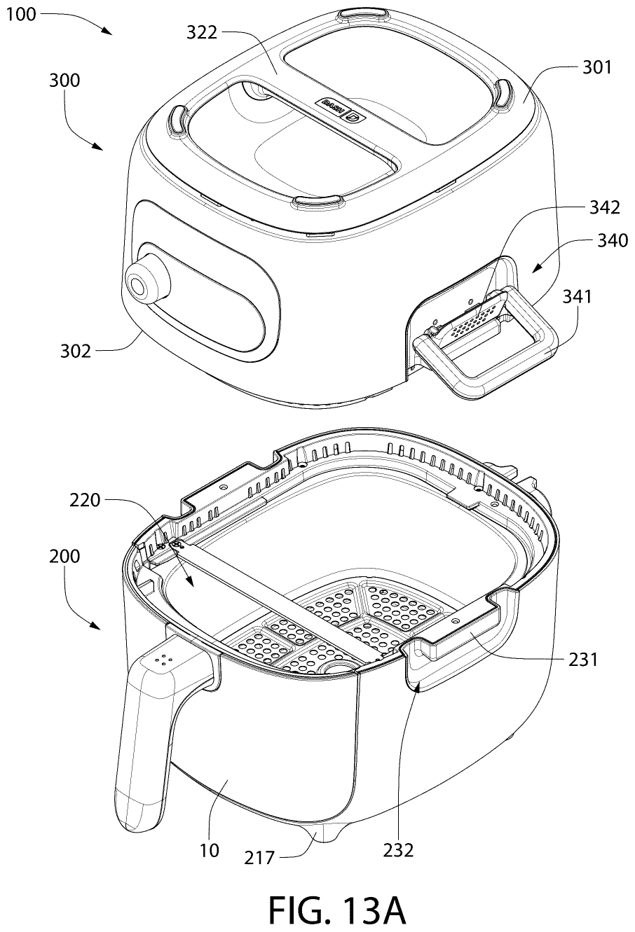

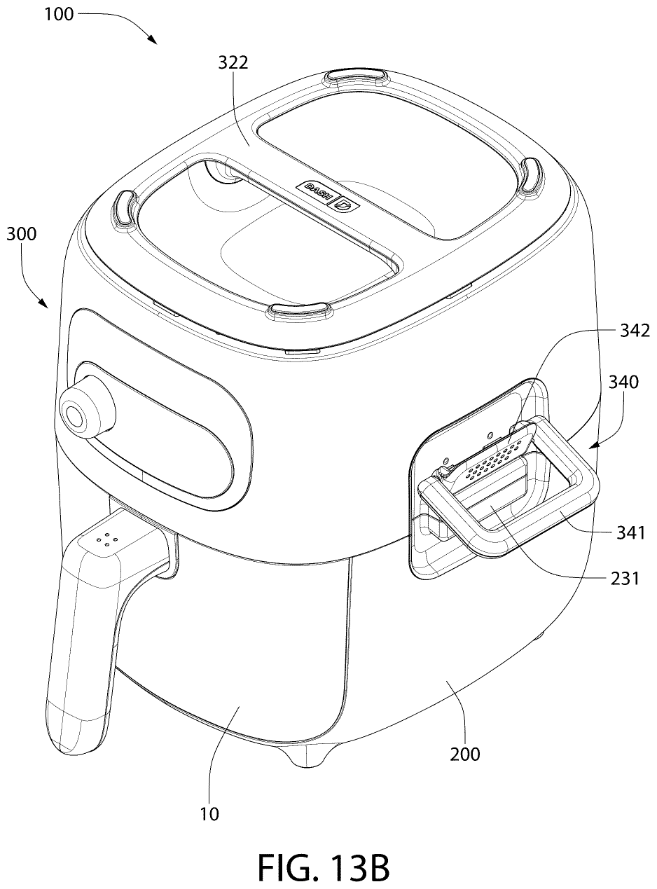

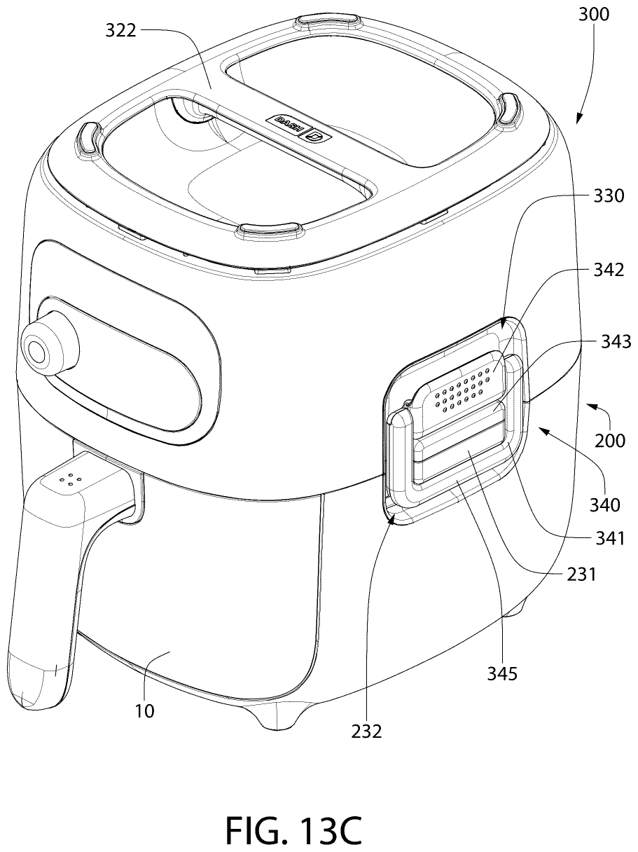

The second locking mechanism 340 may comprise a latch bar 341 and a locking lever 342. The locking lever 342 may be positioned at a location that is spaced apart from the sidewall 332 of the third recess 330. The main housing body 310 may further comprise a protrusion 343 that protrudes from the floor 331 of the recess 330 at a location adjacent to (and perhaps flush with) the second end 312. The protrusion 343 may be elongated across a width of the recess 330 and may correspond in length to the locking protrusion 230, 231 of the base housing 210. The locking lever 342 may be pivotably coupled to the protrusion 343 so that the locking lever 342 can pivot between a locked state and an unlocked state, as described further below (see, for example, FIG. 13B showing the locking lever in the unlocked state and FIG. 13C showing the locking lever in the locked state). The latch bar 341 may be attached to two opposing sides of the locking lever 342. The latch bar 341 may be pivotably or rotatably coupled to the locking lever 342 so that the latch bar 341 is capable of rotation about an axis that intersects both of the attachment points between the latch bar 341 and the locking lever 342.

The latch bar 341 may be rotatable between a locked position, shown in FIG. 6, wherein a portion of the latch bar 351 extends beyond the second end 312 of the main housing body 310 and an unlocked position, shown in FIG. 7, wherein the latch bar 341 extends outwardly from the outer surface 314 of the main housing body 310. In the unlocked position, the latch bar 341 may be located in many different rotational positioned, including positions extending outwardly from the outer surface 314 of the main housing body 310 at various angles an downwardly towards the first end 311 of the main housing body 310.

FIGS. 8A and 8B are exploded views of the heating unit 300. In that regard, each of FIGS. 8A and 8B illustrates the main housing body 310, the support component 320, the heating assembly 350 which comprises the motor 351, the fans 352, and the heating element 353. In the exemplified embodiment, the first and second ends 311, 312 of the main housing body 310 are open. When the support component 320 is coupled to the main housing body 310, the support component 320 closes the second end 312 of the main housing body 310. The heating unit 300 further comprises a motor support tray 360 and a liner 361. The motor support tray 360 may be bowl-shaped having a floor and a sidewall. The motor shaft of the motor 351 may extend through an opening in the floor of the motor support tray 360. The motor support tray 360 may then be coupled to the first end 311 of the main housing body 310 to close the opening in the first end 311. A first fan 352a may be coupled to the motor shaft of the motor 351 and the first fan 352a may be positioned within an interior of the motor support tray 360. The liner 361 may then be positioned within the interior of the motor support tray 360 so that the first fan 352a is positioned in a space between the motor support tray 360 and the liner 361. A second fan 352b may be coupled to an end of the motor shaft of the motor 351 and positioned within an interior of the liner 361. Finally, a heating element support plate 363 to which the heating element 353 is attached may be coupled to the liner 361 so that the second fan 352b is located between the heating element support plate 363 and the liner 361.

FIG. 8B further illustrates a grill plate 400 and a griddle plate 410. Each of the grill plate 400 and the griddle plate 410 may be referred to herein as a cooking plate, as it is intended to hold/support food thereon for cooking. The cooking plates are distinct from the cooking basket 10, as they are completely separate parts. In an embodiment, while the cooking basket 10 is capable of fitting through the front opening 222 of the cooking receptacle 220 of the base unit 200, the cooking plates may be incapable of fitting through the front opening 222 and into the cooking receptacle 220.

The grill plate 400 and the griddle plate 410 are part of the cooking appliance 100, but not part of the heating unit 300. Rather, the grill plate 400 and the griddle plate 410 are separate plate structures that are configured to be coupled to the second end 302 of the heating unit 300 when the heating unit 300 is being used in a second cooking position, shown in FIGS. 10-11C and described in some detail below. Additional plate structures like the grill plate 400 and the griddle plate 410 may also be included as part of the cooking appliance 100 to allow for other cooking styles. The grill plate 400 and the griddle plate 410 are configured to be placed atop of the second end 302 of the heating unit 300 when the heating unit 300 is inverted relative to its orientation shown in FIG. 1. The grill plate 400 and the griddle plate 410 are then capable of supporting food thereon, which is heated by heat generated by the heating element 353. The heat generated by the heating element 353 may be transmitted conductively to the grill and/or griddle plates 400, 410.

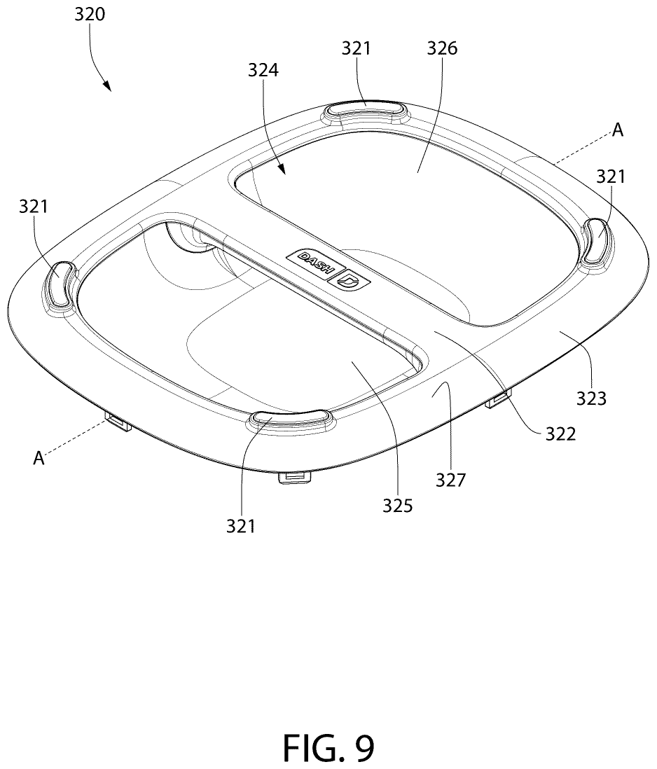

Referring to FIG. 9, the support component 320 will be described. As noted, the support component 320 is intended to be coupled to the main housing body 310 to close the opening in the first end 311 of the main housing body 310. The support component 320 may be coupled to the main housing body 310 with fasteners such as screws or the like so that the support component 320 is fixed to the main housing body 310. Alternatively, the support component 320 may be coupled to the main housing body 310 with a snap fit or friction fit or other mechanical attachment without the use of fasteners. The support component 320 may comprise an annular or ring-shaped portion 323 that surrounds a central portion 324. The central portion 324 may comprise a floor 325 and a sidewall 326 that extends from the floor 325 to the ring-shaped portion 323. The central portion 324 may be bowl-shaped such that the central portion 324 defines a cavity or reservoir below the ring-shaped portion 323. The ring-shaped portion 323 may form a flange that extends radially outward from a distal end of the sidewall 325 of the central portion 324.

The ring-shaped portion 323 comprises an exposed top surface 327 that forms at least a portion of the first end 301 of the cooking appliance 100 when assembled with the heating unit 300 in the first cooking position, as shown in FIG. 1. In the exemplified embodiment, the ring-shaped portion 323 is generally in the shape of a rectangle with rounded corners. In the exemplified embodiment, the one or more support elements 321 are coupled to the exposed top surface 327 of the ring-shaped portion 323. Furthermore, in the exemplified embodiment there are a plurality of the support elements 321. More specifically, there may be four of the support elements 321 arranged in a spaced apart manner along the top surface 327 of the ring-shaped portion 323. Each of the support elements 321 may be coupled to the ring-shaped portion 323 along one of the rounded corners of the ring-shaped portion 323. More specifically, each of the support elements 321 may be coupled to the ring-shaped portion 323 along one of the rounded corners at a position adjacent to an inner edge of the ring-shaped portion 323. Each of the support elements 321 may be arcuate shaped, although this is not required in all embodiments.

In an embodiment, each of the support elements 321 may comprise a pad formed from an elastomeric material or a foam material. The support elements 321 may be referred to as foot pads. The elastomeric material may be rubber, silicone, thermoplastic elastomer, thermoplastic polyurethane, or other similar materials. The support elements 321 may also be pads formed from or comprising cotton, polyester or recycled materials, such as those typically used as furniture pads. In certain embodiments, the heating unit 300 may be configured for use in an inverted orientation relative to its orientation in the first cooking position. In that inverted orientation, the support elements 321 may be placed into direct contact with the support surface (i.e., countertop, tabletop, etc.) upon which the heating unit 300 is positioned. Thus, forming the support elements 321 as pads formed from an elastomeric material or a foam material inhibits the heating unit 300 from sliding along the supporting surface undesirably and also prevents scratching of the underlying support surface.

The support component 320 may further comprise the handle 322 as mentioned above. The handle 3200 may be attached to an inner surface of the ring-shaped portion 323 and/or to the sidewall 326 of the central portion 324 at two locations that are on an opposite side of an axis A-A of the support component 320. Thus, the handle 322 extends across the central portion 324 from one side to the other. The sidewall 326 of the central portion 324 extends downwardly and inwardly from the ring-shaped portion 323 to the floor 325 of the central portion 324. The floor 325 of the central portion 324 is therefore spaced from a bottom surface of the handle 322. As such, a user can readily grip the handle 322 to move the cooking appliance 100 as desired.

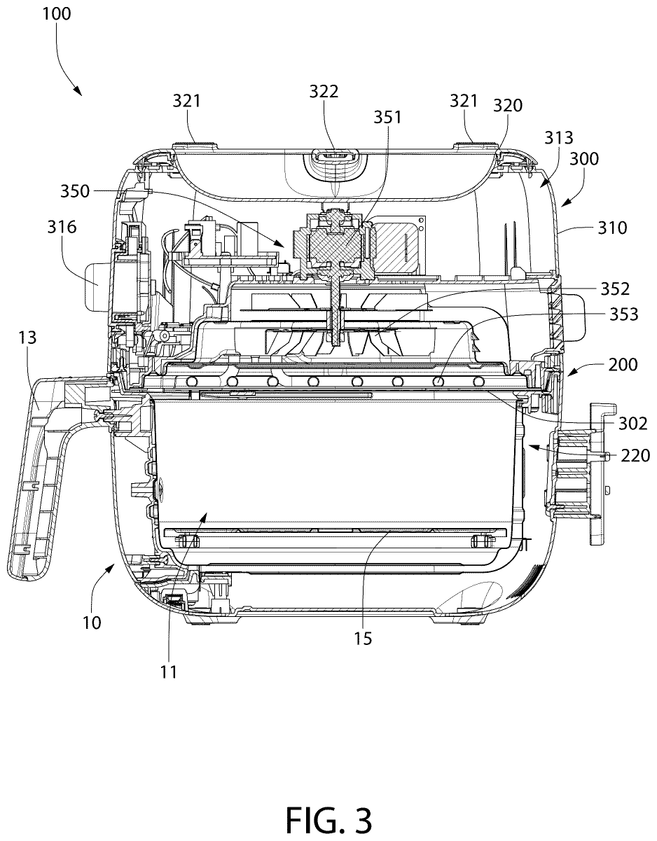

Referring to FIGS. 3 and 9, the outer surface of the handle 322 of the support component 320 does not extend beyond the exposed surfaces of the support elements 321. For example, the outer surface of the handle 322 may be recessed relative to the exposed surfaces of the support elements 321. This ensures that when the heating unit 300 is placed onto a support surface in its inverted orientation, only the exposed surfaces of the support elements 321 contact the support surface while keeping the outer surface of the handle 322 spaced from the support surface. This allows the heating unit 300 to be self-supporting and stable.

Referring to FIG. 10, the heating unit 300 of the cooking appliance 100 is illustrated in its inverted orientation being supported by a support surface 20. As discussed herein, the heating unit 300 may be inverted relative to its orientation in the first cooking position as shown in FIG. 1 and may be used as a stand-alone cooking device separately from the base unit 200. In particular, the heating unit 300 may be inverted and placed onto a support surface 20 (countertop, tabletop, etc.) with the support elements 321 in direct surface contact with the support surface 20. When so positioned, the exposed top surface 327 of the ring-shaped portion 323 of the support component 320 may be spaced slightly from the support surface 20. Thus, the heating unit 300 may function as a stand-alone electric stove or the like by supporting the heating unit 300 directly atop a support surface 20. The position of the heating unit 300 shown in FIG. 10 may be a second cooking position of the heating unit 300 wherein the heating unit 300 is separated and detached from the base unit 200 and inverted relative to the first cooking position so that the one or more support elements 321 are in contact with the support surface 20 and the second end 302 of the heating unit 300 is configured to receive food (or a cooking plate) thereon for cooking.

FIG. 10 also illustrates the grill plate 400 positioned atop of the second end 302 of the heating unit 300. The grill plate 400 may simply rest atop of the second end 302 of the heating unit 300. The grill plate 400 may be in direct contact with the heating element 353 when positioned atop of the second end 302 of the heating unit 300. Furthermore, the grill plate 400 may be formed from a heat conductive material such a metal, for example without limitation copper, aluminum, or iron. Thus, when the heating element 353 is activated to generate heat, that heat may be transferred conductively to the grill plate 400 for heating food items placed thereon. Pots and pans could also be placed directly atop the heating element 353.

Referring to FIGS. 11A-11C, the heating unit 300 is illustrated in its inverted orientation (i.e., the second cooking position) with no cooking plate attached or placed thereon. Thus, the heating elements 353 are exposed at the second end 302 of the heating unit 300. A user may be able to place a pot or pan directly onto the heating elements 353 for heating and cooking. Alternatively, a user may place one of the cooking plates described herein onto the second end 302 of the heating unit 300 and to then place food onto the cooking plates for heating and cooking.

For example, FIG. 11B illustrates the heating unit 300 in its inverted orientation (i.e., the second cooking position) with the grill plate 400 positioned atop of the second end 302 of the heating unit 300. In an embodiment, the grill plate 400 may simply rest atop of the second end 302 of the heating unit 300 without being physically locked thereto. Thus, a user can place the grill plate 400 onto the second end 302 of the heating unit 300 (when in the second cooking position), and then after cooking (and after the grill plate 400 has cooled), the user can lift the grill plate 400 off the second end 302 of the heating unit 300 for cleaning and/or storage.

Similarly, FIG. 11C illustrates the heating unit 300 in its inverted orientation (i.e., the second cooking position) with the griddle plate 410 positioned atop of the second end 302 of the heating unit 300. In an embodiment, the griddle plate 410 may simply rest atop of the second end 302 of the heating unit 300 without being physically locked thereto. Thus, a user can place the grill plate 400 onto the second end 302 of the heating unit 300 (when in the second cooking position), and then after cooking (and after the griddle plate 410 has cooled), the user can lift the griddle plate 410 off the second end 302 of the heating unit 300 for cleaning and/or storage.

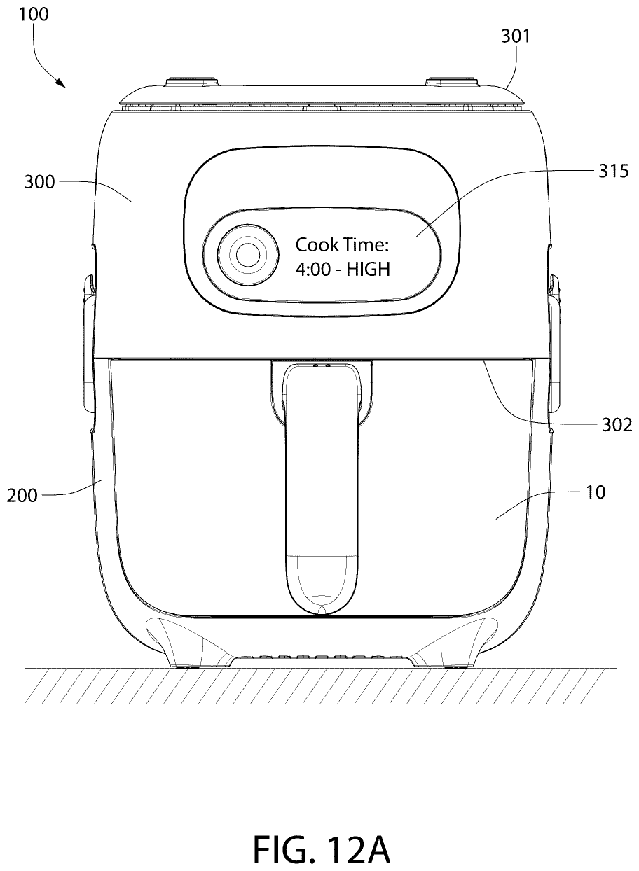

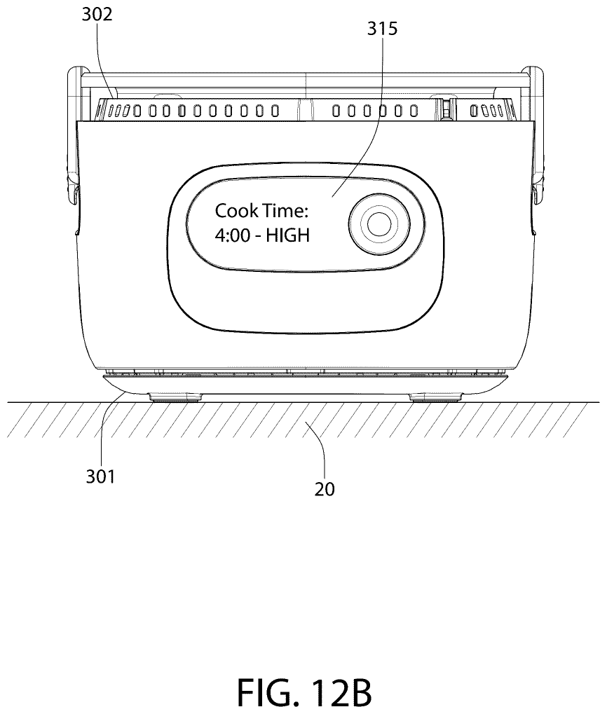

Referring to FIGS. 12A and 12B, a feature of the display 315 of the heating unit 300 will be described. FIG. 12A illustrates the heating unit 300 in the first cooking position wherein the heating unit 300 is placed atop of the base unit 200 with the second end 302 of the heating unit 300 facing downwardly towards the base unit 200 and the first end 301 of the heating unit 300 facing upwardly. As seen in FIG. 12A, the text and/or alphanumeric characters shown on the display 315 are upright with the heating unit 300 in the first cooking position. FIG. 12B illustrates the heating unit 300 in the second cooking position wherein the second end 302 of the heating unit 300 faces upwardly and the first end 301 of the heating unit 300 faces downwardly towards a support surface 20. With the heating unit 300 in this second cooking position which is inverted relative to the first cooking position, the text and/or alphanumeric characters shown on the display remain upright. Thus, as the heating unit 300 is inverted between the first and second cooking positions, the text and/or alphanumeric characters shown on the display are also inverted or flipped so that the text and/or alphanumeric characters always appear upright to the user regardless of the whether the first or second ends 301, 302 of the heating unit 300 are facing downwardly and upwardly. This inverting or flipping of the text on the display may occur automatically based on the orientation of the heating unit 300.

Referring to FIGS. 13A-13C, the attachment of the heating unit 300 to the base unit 100 in the first cooking position will be described. In FIGS. 13A-13C, an attachment will be described with reference to the second locking mechanism 340 of the heating unit 300 and the second locking protuberance 231 of the base unit 200. It should be appreciated that a similar attachment may occur between the first locking mechanism (not shown) of the heating unit 300 and the first locking protuberance 230 of the base unit 200. The discussion of the function and cooperation between the second locking mechanism 340 and the second locking protuberance 231 may be entirely applicable to the first locking mechanism and the first locking protuberance 230.

Referring first to FIG. 13A, with the base unit 200 positioned on a support surface and supported by the legs 217, the heating unit 300 is elevated above the base unit 200 with the second end 302 of the heating unit 300 facing the base unit 200. As the heating unit 300 is elevated above the base unit 200 in preparation for attachment in the first cooking position, the latch bar 341 is extending outwardly or upwardly, but not downwardly towards the base unit 200. The reason to not have the latch bar 341 extending downwardly (i.e., towards the second end 302 of the heating unit 300) is so that it does not contact the second locking protuberance 231 as the heating unit 300 is moved downwardly towards the base unit 200. In the illustration provided, the cooking basket 10 is located within the cooking receptacle 220 of the base unit 200 as the heating unit 300 is placed atop of the base unit 200. However, the cooking basket 10 need not be in the cooking receptacle of the base unit 200 during this process, and the cooking basket 10 could be inserted into the cooking receptacle of the base unit 200 after the Next, as shown in FIG. 13B, the heating unit 300 is lowered until it is positioned atop the top end 212 of the base unit 200. When so positioned, the second end 302 of the heating unit 300 abuts the top end 212 of the base unit 200. Furthermore, the protrusion 343 of the heating unit 300 is aligned and in abutment with the locking protuberance 231 of the base unit 200.

Finally, referring to FIG. 13C, the latch bar 341 is rotated downwardly so that at least a portion of the latch bar 341 nests within the second recess 232 of the base housing 210. The second recess 232 essentially forms a U-shaped channel within which a U-shaped portion of the latch bar 341 nests when rotated downwardly into the locked state/position. The latch bar 341 comprises a central latching portion 345 that nests within the second recess 232 in a location between the locking protuberance 231 and the sidewall 236 of the recess 232. This location of the central latching portion 345 prevents the heating unit 300 from being detached from the base unit 200 without first rotating the latch bar 341 out of the second recess 232 of the base housing 210. Finally, the locking lever 342 may be pivoted from its unlocked state shown in FIGS. 13A and 13B into a locked state. By pivoting the locking lever 342 into the locked state as shown, the latch bar 341 is locked into place by being placed into forcible contact with the lower end of the locking protuberance 231 of the base unit 230. As such, the latch bar 341 cannot be readily pivoted out of the second recess 232 while the locking lever 342 is in the locked state. When the heating unit 300 is positioned atop of the base unit 200 and the locking mechanisms 340 are in the locked state, a user can grip the handle 322 and lift the entire cooking appliance 100 together with the heating unit 300 remaining attached to the base unit 200.

When a user desires to detach the heating unit 300 from the base unit 200 (for example, to use the heating unit 300 in the second cooking position described above), the locking lever 342 is first pivoted back into the unlocked state, and then the latch bar 341 is rotated out of the second recess 232 of the base housing 210. At that point, the heating unit 300 may be lifted up off of the base unit 200 for use in the second cooking position, or for any other purpose such as storage or the like. That is, a user may grip the handle 322 and lift the heating unit 300, which will cause the heating unit 300 to separate from and be lifted away from the base unit 200.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A cooking appliance comprising:
a base unit comprising a cooking receptacle having an open top end;
a heating unit comprising:
a first end and a second end opposite the first end, the first end comprising one or more support elements; and
a heat generating assembly configured to generate heat and emit the heat from the second end of the heating unit for cooking;
wherein the heating unit is detachably coupled to the base unit, the heating unit being alterable between: (1) a first cooking position wherein the heating unit is positioned atop of the base unit to close the open top end of the cooking receptacle with the second end of the heating unit facing the cooking receptacle of the base unit to cook food located within the cooking receptacle of the base unit; and (2) a second cooking position wherein the heating unit is separated and detached from the base unit and inverted relative to the first cooking position so that the one or more support elements are in contact with a support surface and the second end of the heating unit is configured to receive food thereon for cooking.

2. The cooking appliance according to claim 1 wherein the one or more support elements comprise a plurality of support pads configured to be positioned in direct contact with the support surface to support the heating unit in the second cooking position.

3. The cooking appliance according to claim 2 wherein each of the plurality of support pads is formed from an elastomeric material or a foam material.

4. The cooking appliance according to claim 1 further comprising:
the heating unit comprising:
a main housing body comprising a first end and a second end; and
a support component coupled to the first end of the main housing body, the support component comprising the one or more support elements and a handle.

5. The cooking appliance according to claim 4 further comprising:
the support component comprising a ring-shaped portion;
the one or more support elements comprising a plurality of support pads that are attached to the ring-shaped portion; and
wherein the handle is coupled to two opposing sides of the ring-shaped portion and extends across an interior defined by the ring-shaped portion.

6. The cooking appliance according to claim 5 further comprising:
the main housing body comprising a first opening in the first end and a second opening in the second end;
the support component comprising a central portion comprising a floor and a sidewall that extends from the floor to the ring-shaped portion, the handle extending over the floor and being spaced from the floor; and
wherein the support component is coupled to the main housing body and closes the first opening in the first end of the main housing body.

7. The cooking appliance according to claim 1 further comprising:
the heat generating assembly comprising:
a motor and at least one fan operably coupled together, the motor and the at least one fan located within a cavity of the heating unit; and
a heating element that is configured to generate heat, the heating element being exposed at the second end of the heating unit; and
wherein the fan is configured to generate an air stream to circulate the heat generated by the heating element into the cooking receptacle when the heating unit is in the first cooking position.

8. The cooking appliance according to claim 1 further comprising:
the heat generating assembly comprising a heating element that is exposed at the second end of the heating unit; and
a cooking plate configured to be positioned atop of the second end of the heating unit adjacent to the heating element when the heating unit is in the second cooking position, the cooking plate being configured to support food thereon for cooking.

9. The cooking appliance according to claim 8 further comprising a plurality of the cooking plates, wherein the plurality of the cooking plates comprises a grill plate and a griddle plate that are configured to be interchangeably positioned atop of the second end of the heating unit when the heating unit is in the second cooking position.

10. The cooking appliance according to claim 8 further comprising:
the base unit comprising a front opening that forms a passageway into the cooking receptacle; and
a cooking basket configured to hold food for cooking, wherein the cooking basket is configured to be slidably inserted into the cooking receptacle through the front opening of the base unit; and
wherein the cooking plate is separate and distinct from the cooking basket.

11. The cooking appliance according to claim 1 further comprising:
the heating unit comprising a display that is configured to display alphanumeric characters, and wherein the alphanumeric characters are upright when the heating unit is in each of the first and second cooking positions.

12. The cooking appliance according to claim 1 further comprising:
the heating unit comprising a main housing body and at least one latch bar that is pivotable relative to the main housing body;
the base unit comprising a base housing having an outer surface and at least one locking protuberance protruding from the outer surface of the base housing; and
wherein when the heating unit is in the first cooking position, the at least one latch bar is alterable between: (1) an unlocked state whereby the at least one latch bar is not engaged with the at least one locking protuberance and the heating unit is configured to be detached and separated from the base unit; and (2) a locked state whereby the at least one latch engages the at least one locking protuberance and prevents the heating unit from being detached and separated from the base unit.

13. The cooking appliance according to claim 12 further comprising:
the main housing body comprising an outer surface having a first recess, the at least one latch bar located within the first recess;
the outer surface of the base unit comprising a second recess, the at least one locking protuberance protruding from a floor of the second recess; and
wherein when the heating unit is in the first cooking position, the first and second recesses are aligned with one another, and when the heating unit is in the first cooking position and the at least one latch bar is in the locked state, at least a portion of the at least one latch bar nests within the second recess of the base unit.

14. The cooking appliance according to claim 1 further comprising:
the base unit comprising an elongated bar extending across the cooking receptacle at the open top end of the cooking receptacle; and
wherein the elongated bar prohibits the heating unit from nesting within the cooking receptacle of the base unit with the first end of the heating unit facing the cooking receptacle.

15. A cooking appliance comprising:
a base unit comprising an outer surface and a cooking receptacle having an open top end, a first locking protuberance protruding from a first side of the outer surface of the base unit and a second locking protuberance protruding from a second side of the outer surface of the base unit;
a heating unit comprising an outer surface, a heat generating assembly configured to generate heat for cooking, a first latch bar located on a first side of the outer surface of the heating unit, and a second latch bar located on a second side of the outer surface of the heating unit, the first and second latch bars being pivotable relative to the outer surface of the heating unit;
the heating unit being detachably coupled to the base unit in a first cooking position wherein the heating unit closes the open top end of the receptacle; and
wherein when the heating unit is in the first cooking position, the first and second latch bars are alterable between: (1) an unlocked state wherein the first latch bar does not engage the first locking protuberance and the second latch bar does not engage the second locking protuberance and the heating unit is configured to be freely separated from the base unit; and (2) a locked state wherein the first latch bar engages the first locking protuberance and the second latch bar engages the second locking protuberance to prevent the heating unit from being detached from the base unit.

16. The cooking appliance according to claim 15 further comprising:
the base unit comprising a first recess having a first floor located on the first side of the outer surface of the base unit and a second recess having a second floor located on the second side of the outer surface of the base unit, the first locking protuberance protruding from the first floor of the first recess and the second locking protuberance protruding from the second floor of the second recess;
the heating unit comprising a third recess located on the first side of the outer surface of the heating unit and a fourth recess located on the second side of the outer surface of the heating unit, the first latch bar coupled to the heating unit within the third recess and the second latch bar coupled to the heating unit within the fourth recess; and
wherein when the heating unit is in the first cooking position, the first and third recesses are aligned with one another and the second and fourth recesses are aligned with one another.

17. The cooking appliance according to claim 15 wherein in the locked state a portion of the first latch bar is located adjacent to a bottom edge of the first locking protuberance and a portion of the second latch bar is located adjacent to a bottom edge of the second locking protuberance.

18. The cooking appliance according to claim 15 wherein when the first and second latch bars are in the unlocked state, the heating unit is configured to be altered from the first cooking position wherein the heating unit is located atop of the base unit with a second end of the heating unit facing the cooking receptacle of the base unit and a first end of the heating unit facing in an upward direction to a second cooking position wherein the heating unit is inverted relative to the first cooking position such that the first end of the heating unit rests directly atop of a support surface and the second end of the heating unit faces in the upward direction.

19. The cooking appliance according to claim 18 further comprising:
the first end of the heating unit comprises a plurality of support pads and a handle;
the second end of the heating unit comprises a heating element that is configured to generate heat for cooking; and
at least one cooking plate configured to be positioned on the second end of the heating unit to be heated by the heating element, the at least one cooking plate configured to support food thereon for cooking.

20. A cooking appliance comprising:
a base unit comprising a cooking receptacle having an open top end and a front opening;
a cooking basket configured to be slidably inserted into the cooking receptacle through the front opening of the base unit;
a heating unit comprising:
a first end and a second end opposite the first end, the first end comprising one or more support elements; and
a heat generating assembly configured to generate heat and emit the heat from the second end of the heating unit for cooking, the heat generating assembly comprising a heating element that is exposed at the second end of the heating unit;
wherein the heating unit is alterable between: (1) a first cooking position wherein the heating unit is attached to the base unit and closes the open top end of the cooking receptacle with the second end of the heating unit facing the cooking receptacle to cook food located in the cooking basket; and (2) a second cooking position wherein the heating unit is separated from the base unit and positioned with the one or more support elements in direct contact with a support surface and the second end of the heating unit facing upwardly; and
a cooking plate configured to be positioned atop of the second end of the heating unit when the heating unit is in the second cooking position, the cooking plate configured to support food thereon to be heated by the heat generated by the heating element of the heat generating assembly.
